(19) United States
(12) Patent Application Publication
(10) Pub. No.: US 2008/0209792 A1
(43) Pub. Date: Sep. 4, 2008

(54) Waddle Motion #3

(76) Inventor: Robert Watlov, Rogers, MN (US)

Correspondence Address: WILSON DANIEL SWAYZE, JR., 3804 CLEARWATER CT., PLANO, TX, 75025, US

(21) Appl. No.: 12/025,006

(22) Filed: Feb. 2, 2008

Related U.S. Application Data
(60) Provisional application No. 60/899,077, filed on Feb. 2, 2007.
(60) Provisional application No. 60/926,553, filed on Apr. 27, 2007.

(51) Int. Cl. A01M 31/06

(52) U.S. Cl. 43/2; 43/3

(57) ABSTRACT

A device to provide waddle and feeding movement for a decoy may include a stake member to support the device and an arm member connected to the stake member to limit the movement of the decoy. The decoy may rotate in response to wind, and an interior of the decoy may cooperate with the arm member to limit the movement of the decoy. The device may include a top sleeve member to cover a portion of the stake member and the top sleeve member may be decorated to mimic the decoy. The device may include a stabilizing member to limit the vertical movement of the decoy but not prevent realistic vertical feeding motion. The stabilizing member may rotate to provide waddle movement for the decoy. The stabilizing member may be a disk, and the arm member may include an arm stabilizing sleeve member. The arm stabilizing sleeve member may be formed from flexible material, or the arm stabilizing sleeve member may be formed from a cushioning material. The stake member may be positioned forward of the pivot point of the decoy or the stake member may be positioned approximately at the pivot point of the decoy.

### PRIORITY

The present application claims priority under 35 USC section 119 based on provisional application Ser. No. 60/899,077 which was filed on Feb. 2, 2007 and provisional application Ser. No. 60/926,553 which was filed on Apr. 27, 2007.

### FIELD OF THE INVENTION

The present invention relates to devices associated with game hunting including duck hunting, and more particularly to a device to provide motion to a duck decoy.

### BACKGROUND OF THE INVENTION

Hunters often use decoys to attract prey into an area which the prey would consider safe. Water fowl decoys are well known which mimic the shape and coloration of a water fowl. Various types of decoys are used on land while other types of decoys are used to float in water. The floating decoys are placed by the hunter in water to which the ducks are attracted. The decoys typically have a fowl shaped body made of a buoyant material using a variety of methods. Early decoys were carved from wood which often became water logged and did not last long. Later, decoys were carved from cork. While the cork decoys were more buoyant and lighter to carry, the cork decoys also degraded over time. Recently, most decoys are produced from blown-molded plastic. The decoys are inexpensive and very light weight. However, these decoys are easily damaged and must be replaced often.

Decoys have also been made from styrofoam with cloth covers. However, these decoys are easily torn and destroyed. Also, decoys have been made from urethane foam which produces a solid foam decoy. The solid foam decoy is, however brittle and therefore subject to breakage. This type of foam decoy does not allow the decoy to have detailed features to more accurately mimic a live water fowl.

### SUMMARY

A device to provide waddle and feeding movement for a decoy may include a stake member to support the device and an arm member connected to the stake member to limit the movement of the decoy. The decoy may rotate in response to wind, and an interior of the decoy may cooperate with the arm member to limit the movement of the decoy.

The device may include a top sleeve member to cover a portion of the stake member and the top sleeve member may be decorated to mimic the decoy.

The device may include a stabilizing member to limit the vertical movement of the decoy but not prevent realistic vertical feeding movement, the stabilizing member may rotate to provide waddle movement for the decoy.

The stabilizing member may be a disk, and the arm member may include an arm stabilizing sleeve member.

The arm stabilizing sleeve member may be formed from flexible material, or the arm stabilizing sleeve member may be formed from a cushioning material.

The stake member may be positioned forward of the pivot point of the decoy or the stake member may be positioned approximately at the pivot point of the decoy.

The stake member may be connected to an attachment apparatus for attachment to the decoy, and the attachment apparatus may include a substantially planar plate.

The substantially planar plate may be connected to a cylinder which mounts onto the stake member, and the attachment apparatus may include another substantially planar plate to mount on the decoy.

The planar plate may include Velcro to connect to another substantially planar plate.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a decoy stand in accordance with the teachings of the present invention;

FIG. 2 illustrates the decoy stand being used in conjunction with a decoy;

FIG. 3 illustrates in another embodiment of the decoy stand;

FIG. 4 illustrates the decoy stand to be used in conjunction with the attachment apparatus of the present invention;

FIG. 5 illustrates the attachment apparatus of the decoy stand;

FIG. 6 illustrates the decoy, attachment apparatus and decoy stand of the present invention.

### DETAILED DESCRIPTION

The present invention is a system to create natural looking waddle motion (walking motion) and feeding motion in a decoy spread. The present invention is a motion system which is substantially universal in that it can be attached to substantially all shell decoys and full-bodied decoys. The present invention is simple to install, simple to use and can be adapted to the style and brand of any decoy. The present invention is primarily activated by wind and can eliminate exaggerated motion. The present invention includes a decoy motion system that not only can be attached to presently available decoys but also can be adapted for future decoys. The stake and attachment system allows the user much better lifelike movement in the decoy spread. The present invention provides natural waddle and feeding movement by taking advantage of the pivot point or balance point of the decoy and attaching an apparatus to the underside of the decoy at the balance point or just ahead of the balance point to achieve the natural waddle and feeding movement. The present invention employs a strong attachment stake and is adapted to accept a cosmetic sleeve which may be painted with color to match the legs of the waterfowl species to be imitated. The bottom of the stake can be sprayed or formed from any number of shapes to securely anchor a stake in the ground, holding the decoy in place. If the decoy includes a accepting cylinder for the stake on the undersigned of the decoy, the decoy accepting cylinder is placed over the stake and the decoy will wattle with wind activation. If the decoy has a hole drilled through the decoy back at the pivot point or balance point of the decoy, the stake may be secured in the ground and the decoy is placed on top of the stake so the stake passes through the hole in the back of the decoy. The stake is secured in a ground, and the decoy is placed on top of the stake which allows a rotating stabilizer attached to the stake above the stake arm to control the movement of the decoy by the rotating stabilizer and the stake. Alternatively, the Velcro or other attachment material may be placed on the underside of the decoy near the balance point or just in front of the balance point to allow the decoy to be placed on a cylindrical piece and Velcro is placed on a stop plate to be attached to the underside of the decoy. Again, the decoy will waddle in accordance with wind activation. The amount of the waddle is controlled by a traverse arm that protrudes out from the side of the stake with cushioned absorbing noise reduction material attached to the traverse arm to prevent the decoy from rotating 360°. The decoy itself contacts the traverse arm. As a result of the flexibility of the cushioning material, the decoy will bounce about in any direction, causing the waddle movement of the decoy as it bounces back and forth with wind activation.

Decoys having a manufactured hole in the back of the decoy near the pivot point or balance point can be adapted to cooperate with a rotating stabilizer apparatus in order to keep the decoy from over exaggerated vertical motion and to ensure that the decoy will move easily in a small amount of wind, or any manual or motorized force.

The decoys employing the present invention can be placed in many directions with respect to wind direction to enhance the action which depends on how the wind catches the decoy. The resulting motion of the decoy is therefore very realistic.

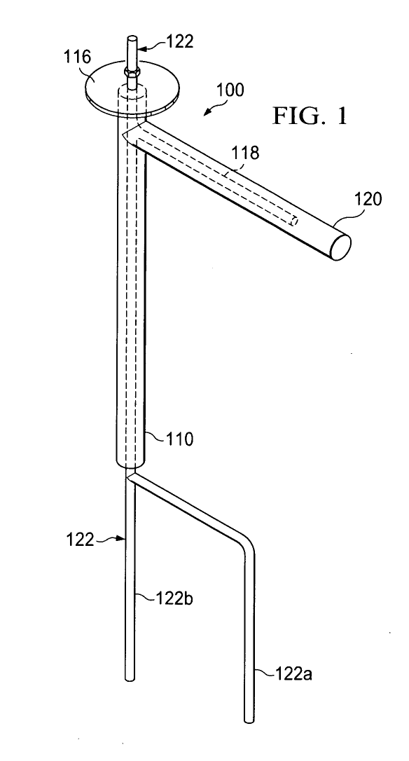

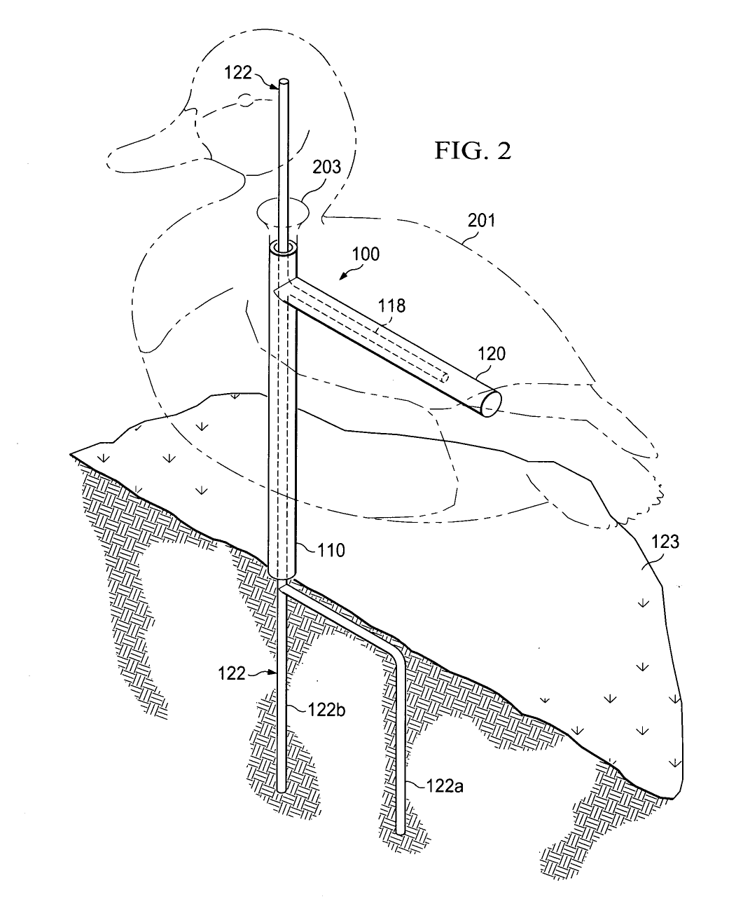

FIG. 1 illustrates the waddle motion #3 or decoy stand 100 to mount to a decoy 201 as illustrated in FIG. 2 such as a duck decoy which may be either a shell or solid duck decoy or other type of suitable decoy. FIG. 1 additionally illustrates a stake member 122 which includes a bottom portion segment 122b which may be placed in the ground to anchor the decoy stand 100. The decoy stand 100 includes a top sleeve member 110 which adds to the cosmetic aspect of the decoy stand 100.

The top sleeve member 110 may be a hollow cylinder or tube to be positioned at one end of the stake member 122 as seen in FIG. 1 and may be formed from rigid material. FIG. 1 additionally illustrates a stabilizing member 116 which may be a disc having a center aperture to cooperate with the stake member 122 to allow the stabilizing member 116 to rotate which in turn allows the decoy to rotate but prevents the decoy from excessive movement in the vertical direction. Typically, the stabilizing member 116 is positioned on the stake member 122 on top of the top sleeve member 110 and may be retained on the stake member 122 by a fastening device such as a nut or welded washer. FIG. 1 illustrates an arm member 118 which extends from the stake member 122 substantially parallel to the ground surface in order to stabilize the decoy from excessive motion. The arm member 118 may be covered with a stabilizing sleeve member 120 which may be in the form of a cylinder or tube formed from flexible material or cushion material in order to give the decoy a bounce to simulate the waddle and feeding motion of a duck.

The top sleeve member 110 may be painted a color to match the natural coloring of the species that the decoy is intended to mimic.

FIG. 2 illustrates the decoy stand 100 with a mounted duck decoy 201 which could be a duck or other type of decoy, the decoy stand 100 may be mounted forward of the pivot point or center of gravity of the decoy 201 and takes advantage of the aperture 203 which is located within the decoy 201 and allows the stake member 122 to extend within the decoy 201. The body or housing of the decoy 201 may be hollow to cooperate with the arm member 118 and the arm stability sleeve member 120. As the wind directs the decoy 201 in one direction or another, the decoy 201 will rotate with respect to the stake member 122. However, the rotation of the decoy 201 is limited by virtue of the side of the housing of the decoy 201 striking or touching the arm stability sleeve member 120, and by virtue of the flexibility of the arm stability sleeve 120, the decoy 201 will rotate in the opposite direction by virtue of the collision of the housing of the decoy 201 and the arm stability sleeve member 120. The decoy 201 may rotate so that the opposite side of the housing of the decoy 201 collides with the arm stability sleeve member 120 resulting in the process being repeated or alternatively, the wind may again rotate the decoy 201 to cause an another collision with the housing of the decoy 201. As a result of this movement, the decoy 201 achieves a lifelike waddle and feeding movement which attracts like animals to the decoy 201.

Additionally, the stake member 122 includes a stand mounting segment 122a of the stake member 122 for mounting the decoy stand 100 in the ground 123, and the stand mounting segment 122a of the stake member 122 which extends out of the bottom of the top sleeve member 110. The stand mounting segment 122a and the bottom stake segment 122b of the stake member 112 is shown as an inverted U shaped device, but could take on many different forms as long as it securely anchors the decoy stand in the ground.

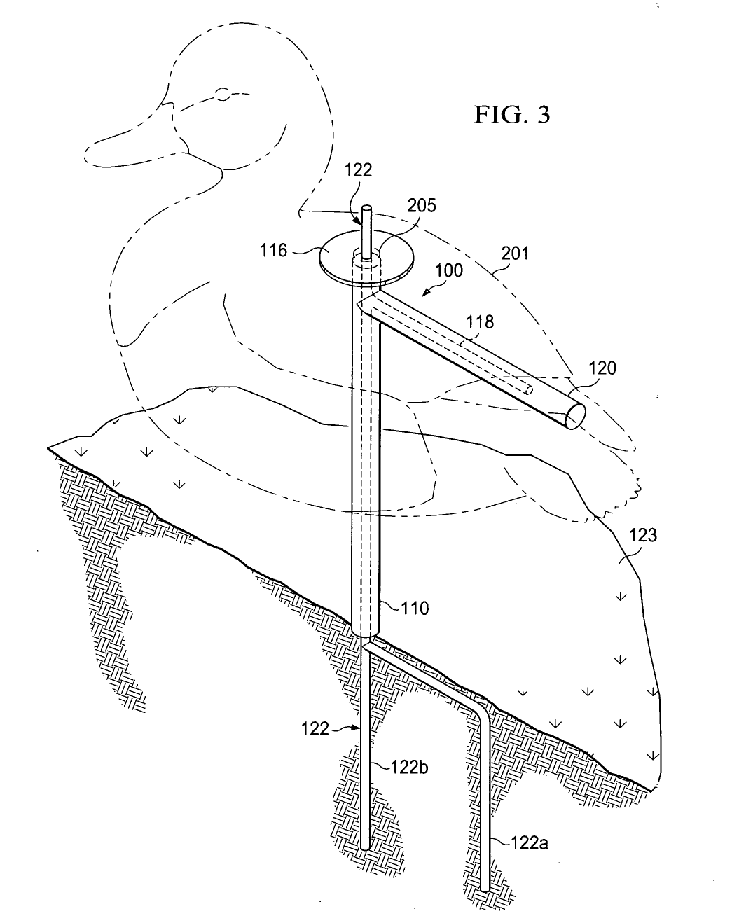

FIG. 3 illustrates another embodiment of the present invention with the decoy stand 100 being positioned approximately at the pivot point or center of gravity. The stake member 122 extends into the hollow housing of the decoy duck 201 and through the stabilizing member 116 and extends through an aperture 205 of the housing of the decoy 201 to allow the stabilizing member 116 to cooperate with the inner surface of the housing of the decoy 201 so that the decoy 201 can rotate with the stabilizing member 116 in accordance with the wind. The decoy 201 has controlled movement in the vertical resulting from the resistance due to the stabilizing member 116. Furthermore, the rotation is further limited due to the arm member 118 and the arm stability sleeve member 120 as described above.

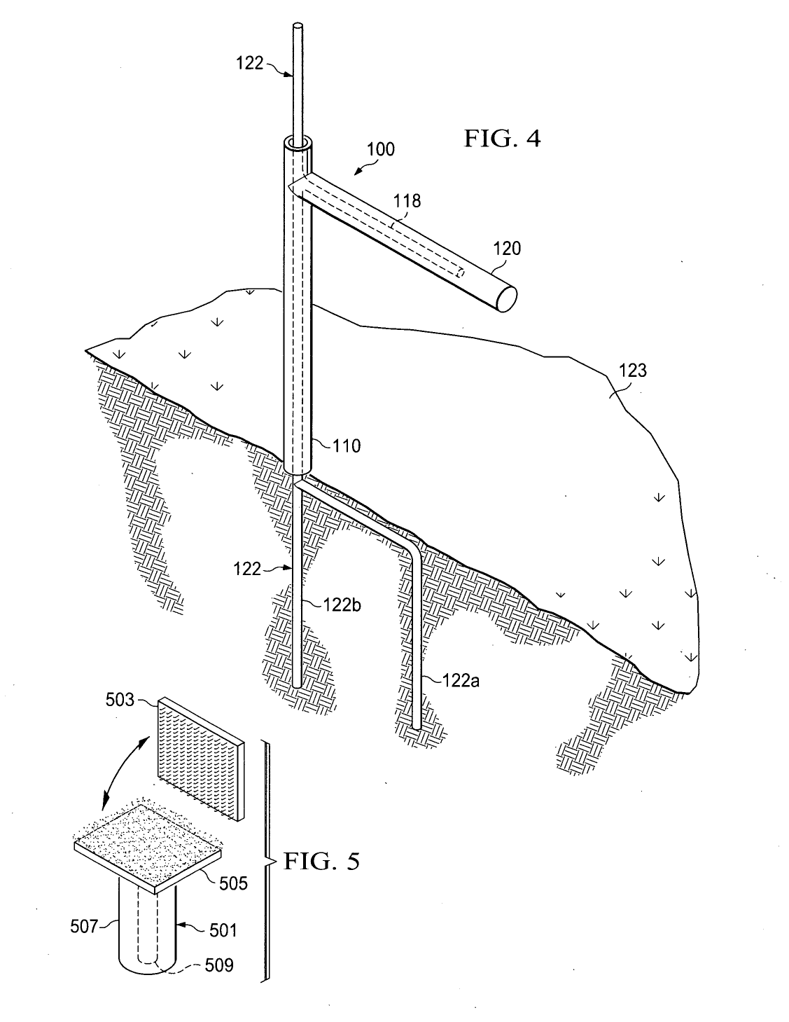

FIG. 4 illustrates another embodiment of the present invention. FIG. 4 illustrates that the stake member 122 extends beyond the top sleeve member 110 in order to cooperate with the attachment apparatus 501, 503 as illustrated in FIG. 5. FIG. 4 illustrates that the arm member 118 and the arm stability sleeve member 120 are used to cooperate with the interior of the housing of the decoy 201.

FIG. 5 illustrates an attachment apparatus 501, 503 to attach to a solid or hollow decoy and which includes a substantially planar platform 505 mounted transversely to the longitudinal direction of a cylinder or tube 507 having a center aperture 509 which cooperates with the end of the stake member 122. FIG. 5 illustrates a second substantially planar platform 503 which is attached to the interior of the housing of the decoy 201. The surface of the substantially planar platform 505 and the second substantially planar platform 503 may include Velcro which are hooks and loops or other suitable material for attachment of the decoy 204 to the decoy stand 100. The attachment apparatus 501 may take the form of a thick cylindrical stabilizing member, like 116 in FIG. 1, having a center aperture 509, which cooperates with the top end of the stake member 122. In this form of the attachment apparatus 501, the thick cylindrical stabilizer member is longer longitudinally than the top of the stake is high, not allowing the stake to protrude up through the top of the thick cylindrical stabilizing member, like it does in FIG. 1 and FIG. 3. This form of the attachment apparatus 501 would also have the substantially planar platform 505 mounted traversely to the longitudinal direction of the cylinder.

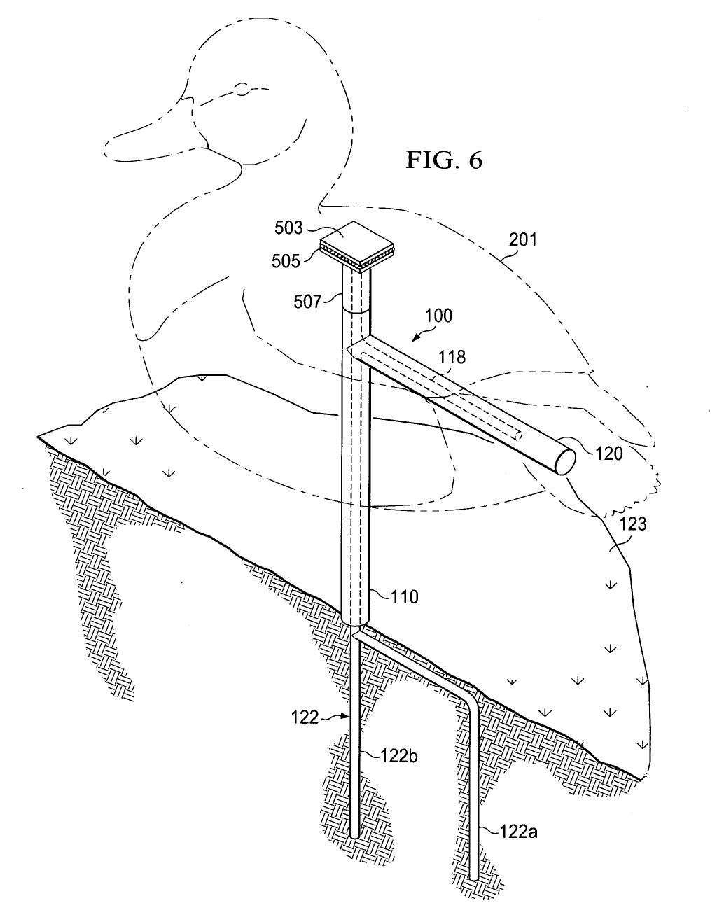

FIG. 6 illustrates the decoy stand as shown in FIG. 4 and the attachment member 501, 503 as illustrated in FIG. 5. FIG. 6 illustrates that the stake member 122 extends beyond the top sleeve member 110 and extends within the hollow housing of the duck stand 100 in order to cooperate with the attachment apparatus 501, 503. FIG. 6 illustrates that the arm member 118 and the arm stability sleeve 120 are used to cooperate with the interior of the housing of the decoy 201.

FIG. 6 illustrates an attachment apparatus 501, 503 attached to a solid or hollow decoy 201 and which includes the substantially planar platform 505 mounted transversely to the longitudinal direction of a cylinder or tube 507 having a center aperture 509 which cooperates with the end of the stake member 122. FIG. 6 illustrates a second substantially planar platform 503 which is attached to the interior of the housing of the decoy 201. The surface of the substantially planar platform 505 and the second substantially planar platform for 503 may include Velcro which are hooks and loops or other suitable material for attachment of the decoy 201 to the decoy stand 100.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A device to provide waddle and feeding movement for a decoy, comprising:
a stake member to support the device;
an arm member connected to the stake member to limit the movement of the decoy;
Wherein the decoy rotates in response to wind, and an interior of the decoy cooperates with the arm member to limit the movement of the decoy.

2. A device to provide waddle and feeding movement for a decoy as in claim 1, wherein the device includes a top sleeve member to cover a portion of the stake member.

3. A device to provide waddle and feeding movement for a decoy as in claim 2, wherein the top sleeve member is decorated to mimic the decoy.

4. A device to provide waddle and feeding movement for a decoy as in claim 1, wherein the device includes a stabilizing member to limit the vertical movement of the decoy but not prevent realistic vertical feeding movement.

5. A device to provide waddle and feeding movement for a decoy as in claim 4, wherein the stabilizing member rotates to provide waddle and feeding movement for the decoy.

6. A device to provide waddle and feeding movement for a decoy as in claim 5, wherein the stabilizing member is a disk.

7. A device to provide waddle and feeding movement for a decoy as in claim 1, wherein the arm member includes an arm stabilizing sleeve member.

8. A device to provide waddle and feeding movement for a decoy as in claim 7, wherein the arm stabilizing sleeve member is formed from flexible material.

9. A device to provide waddle and feeding movement for a decoy as in claim 7, wherein the arm stabilizing sleeve member is formed from a cushioning material.

10. A device to provide waddle and feeding movement for a decoy as in claim 1, wherein the stake member is positioned forward of the pivot point of the decoy.

11. A device to provide waddle and feeding movement for a decoy as in claim 1, wherein the stake member is positioned approximately at the pivot point of the decoy.

12. A device to provide waddle and feeding movement for a decoy as in claim 1, wherein the stake member is connected to an attachment apparatus for attachment to the decoy.

13. A device to provide waddle and feeding movement for a decoy as in claim 12, wherein the attachment apparatus includes a substantially planar plate.

14. A device to provide waddle and feeding movement for a decoy as in claim 13, wherein the substantially planar plate is connected to a cylinder which mounts onto the stake member.

15. A device to provide waddle and feeding movement for a decoy as in claim 13, wherein the attachment apparatus includes another substantially planar plate to mount on the decoy.

16. A device to provide waddle and feeding movement for a decoy as in claim 14, wherein the planar plate includes Velcro to connect to another substantially planar plate.
